(19) United States
(12) Patent Application Publication
(10) Pub. No.: US 2026/0288688 A1
(43) Pub. Date: Sep. 24, 2026

(54) DE-NOISING DATA USING TREE-BASED ITERATIVE COMPRESSION

(71) Applicant: HEWLETT PACKARD ENTERPRISE DEVELOPMENT LP, Spring, TX (US)

(72) Inventors: Nuthan Prasad Bangalore Narasimhamurthy, San Jose, CA (US); Manoj Srivatsav, Bangalore (IN); Aesha Dhar Roy, Bangalore (IN); Aravind C V, Bangalore (IN); Rakesh Kum Dash, Bangalore (IN); Mayukh Dutta, Bangalore (IN)

(21) Appl. No.: 19/213,593

(22) Filed: May 20, 2025

(30) Foreign Application Priority Data
Mar. 20, 2025 (IN) 202541025184

(51) Int. Cl. G06F 16/22; G06F 16/28

(52) U.S. Cl. CPC G06F 16/2246; G06F 16/285

(57) ABSTRACT

Systems and methods are provided for de-noising and compressing data, such as log entries iteratively/recursively such that the log entries can be represented by nodes of a hierarchical tree. The nodes of the hierarchical tree include nodes representative of repeating operational behaviors reflected by a subset of the log entries, and nodes representative of non-repeating operational behaviors reflected by another subset of the log entries. Non-repeating operational behaviors may be indicative of anomalous or unique events or behaviors that may be further analyzed, addressed, etc.

### BACKGROUND

An enterprise (e.g., a business organization, a government agency, an educational organization, an individual, or any other type of organization, or any combination of one or more of each of the foregoing) can employ storage arrays on which storage volumes can be deployed. The storage arrays may be used by users of the enterprise, whether internal users or external users. For example, the storage arrays may be part of a data center. Alternatively, the storage arrays may be accessible in a cloud.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example system or network in which storage arrays can be used, where the storage arrays may generate logs that examples of the disclosed technology may de-noise and compress.

FIG. 2 is a schematic representation of a storage log analyzer, and a corresponding cluster graph representative of log events that have been clustered in accordance with examples of the disclosed technology.

FIG. 3 illustrates an example set of log entries, and their corresponding compressed representations.

FIG. 4 illustrates an example hierarchical tree structure that can be derived in accordance with examples of the disclosed technology.

FIG. 5 is a computing component that may be used to implement de-noising and compression of data in accordance with examples of the disclosed technology.

FIG. 6 depicts a block diagram of an example computer system in which various examples of the disclosed technology described herein may be implemented.

The figures are not exhaustive and do not limit the present disclosure to the precise form disclosed.

### DETAILED DESCRIPTION

Analyzing system data in order to identify certain occurrences, such as anomalous (or otherwise, non-standard) events, can be performed to aid in troubleshooting a system, to optimize system operation, etc. An issue that arises in the context of analyzing storage array system data is that the volume of data generated by such systems can be massive. A single storage array or device can have multiple applications running on multiple processors, e.g., processing inputs/outputs (I/Os). Each of these processors logs information about their operation, and may periodically send log files to a central management server. As an example, on a daily basis, a central management server may receive log files from 2500 processors comprising four million log lines. It can be appreciated that analyzing this amount of data is extremely challenging using conventional systems and methods of data analysis. Moreover, much of the information in these log files is oftentimes, merely typical back/forth communications, e.g., request/response acknowledgements (ACKs), or otherwise “non-interesting” information. An example of such information is the information generated by a processor when a kernel is restarted, which can include messages regarding the setting of memory segments of certain addresses, registering Peripheral Component Interconnect Express (PCIE) devices, device discovery, expanding kernel slots, etc., commonly referred to as “happy path log lines,” where no exceptional or error conditions exist.

Accordingly, examples of the disclosed technology are directed to de-noising data to be analyzed, while isolating meaningful data patterns, e.g., excluding happy path scenarios, and focusing on data patterns that are indicative of some unique or anomalous event or operation. Anomalous or non-standard events may include, but are not limited to, operations, e.g., I/O operations, messages, errors, series of processes that are related to the functionality of a storage array, processing unit, or other device/system of interest that do not follow or comport with operations that are considered the norm/standard for that device/system. It should be noted that anomalous or non-standard need not necessarily imply that an operation is problematic operation or an operation with negative operational implications. Again, non-standard or anomalous in this context can refer to events or operations that don't follow a typical pattern of operations or events for that device/system. More particularly, examples of the disclosed technology are directed to systems and methods of implementing tree-based iterative compression (TBIC) based on identifying repeating subsequences in a sequence of regex indices representative of patterns in log line entries, renaming the identified repeating subsequences, and repeating the processing of identifying repeating subsequences until no more repeating subsequences are found. Ultimately, a hierarchical tree can be constructed that represents received log information, and in doing so, unique or anomalous log entries can be identified without having to traverse/analyze millions of log lines.

Solutions to technical problems rooted in computer technology are provided in accordance with examples of the disclosed technology. As noted above, the difficulty associated with analyzing log events or other system data is due in part, to the amount of events/data to be analyzed. In the context of enterprise storage arrays, as discussed above, a human operator would have to analyze, on the order of millions of log lines or entries across 2500 devices (not to mention further complications because of myriad different types of log files made up by log entries/data), which would be impossible from a practicality standpoint. That is, the amount of time a human operator would need to analyze such events/data would result in impractical delays, even beyond that associated with conventional systems and methods of data analysis. Moreover, the de-noising of the data to be analyzed results in orders of magnitude less computing power and resources being used because the use of IDs to replace recurring data patterns, and the creation of hierarchical tree structures isolates the events/data to be analyzed, avoiding any need to analyze the typical/recurring patterned events/data. Further still, the accuracy of such analyzes can be increased by virtue of avoiding having to consider the typical/recurring patterned events/data representative of happy path events or data.

In operation, a set of log files are selected for analysis. Individual log entries/lines in the set of log files is converted into a vector embedding. In some examples, that vector embedding can be derived using a Beijing Academy of Artificial Intelligence (BAAI) general embedding (BGE) model, although other models or mechanisms can be used to generate vector embeddings. The vector embeddings can be clustered in order to group similar log events. Similar log events can refer to events that exhibit similar (or the same) characteristics, whether it be an address associated with an operation, a memory register, some identifier, or aspects of an event description. Each cluster of vector embeddings (numerical representations of the log entries) can then be represented by a regular expression (regex). Generally, an expression can refer to some combination of text, characters, numbers, or other objects/identifiers/values, etc. that characterize, define, or represent some data or information, other than the data/information itself. A regex can refer to a sequence of characters that specifies a match pattern in text, where such patterns are typically used by string-searching algorithms. Ultimately, a regex represents a pattern shared by all the log entry embeddings in a cluster. Each regex may then be assigned a unique index. The assigned indices may form a “vocabulary” that can be used to describe or characterize the log entries, more specifically, the component parts or aspects of the log entries. In this way, similar log entries (save for ID information) can be represented using the same regex. The result is a sequence of indices.

The sequence of regex indices can then be analyzed to detect repeating patterns, which represent recurring operational behaviors, typically happy path scenarios. Operational behaviors can refer to any operations, processing events, communications, or any interactions that a device/system of interest may engage in, and in the case of log events, log events can comprise summaries or information associated with/informative of those operational behaviors. As discussed above, some examples may include, but are not limited to, typical back/forth communications, e.g., request/response acknowledgements (ACKs), information generated by a processor when a kernel is restarted, which can include messages regarding the setting of memory segments of certain addresses, registering Peripheral Component Interconnect Express (PCIE) devices, device discovery, expanding kernel slots, etc. Patterns representative of log entries that do not repeat can be identified. A probability model that estimates the prevalence of log entries across similar storage arrays/systems can be developed, and non-repeating patterns can be compared to such a probability model to accurately identify anomalous or unique patterns. Such a model need not necessarily refer to an artificial intelligence (AI)/machine learning (ML) model, but some representation, e.g., mathematical or algorithmic representation of probabilities that a system or component will perform or undergo some operational behavior(s).

In order to analyze sequences of regex indices, the sequence of regex indices can be transformed into hierarchical tree structures by recursively identifying and replacing repeating sub-sequences in accordance with a TBIC method. More particularly, a sequence of regex indices is scanned to identify the longest non-overlapping repeating subsequences (which represent recurring patterns or operations). Each such subsequence is replaced with a node identifier. Instead of myriad log lines with addresses/operations/etc., a node identifier now represents compressed versions of repeating patterns, resulting in data compression. This identifying/replacing with node identifiers is repeated on the newly generated sequence to find additional repeating subsequences until no other repeating subsequences are found.

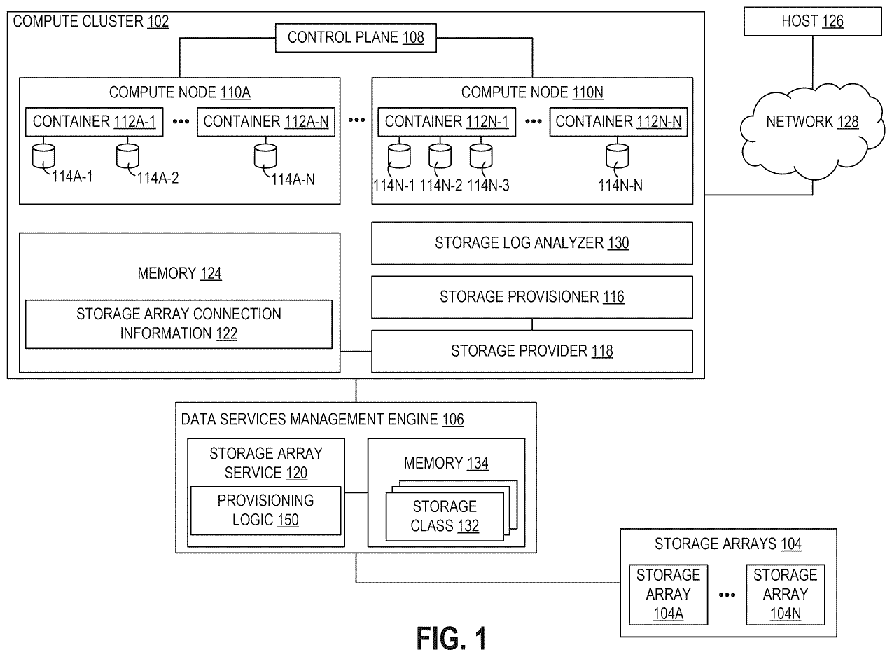

FIG. 1 illustrates an example system or network in which storage arrays can be used/managed. Thus, FIG. 1 is a block diagram of an example arrangement in which examples of the disclosed technology can be implemented, and can include a compute cluster 102, a plurality of storage arrays 104, and a data services management engine 106.

In some examples, the data services management engine 106 may be implemented with processing resources that are separate from the processing resources of the compute cluster 102. For example, the data services management engine 106 may be part of a cloud, part of a web server, part of a data center, and so forth. In other examples, the data services management engine 106 may be implemented with processing resources that are part of the compute cluster 102.

The compute cluster 102 includes a control plane 108 and one or more compute nodes 110A-110N (collectively, 110) that are worker nodes of the compute cluster 102. The control plane 108 includes control services (implemented with machine-readable instructions) that perform control tasks to manage the compute cluster 102, including deploying programs on the compute nodes, removing programs from the compute nodes, managing storage volumes, and so forth. The control services of the control plane 108 can be executed on one or more computers (which can be the same as or different from compute nodes 110). As used herein, a “compute node” can refer to a virtual machine (VM) or a physical computer. A “worker node” is a node with processing resources that is able to perform computational workloads, such as based on execution of a program that includes machine-readable instructions on the compute node.

In some examples, the compute cluster 102 can be a Kubernetes cluster. In Kubernetes, compute nodes within a compute cluster pool together their resources (processing and storage resources) to distribute workloads across the compute nodes. In some examples, the control plane 108 can present an interface, such as an application programming interface (API) or another type of interface, that can be used by other entities to interact with the compute cluster 102. For example, the other entities can send commands to the compute cluster 102 through the interface. The commands can be used to deploy programs in the compute cluster 102, view and manage resources of the compute cluster 102, and so forth.

In some examples, each compute node 110 includes a collection of containers 112A-1 to 112A-N, 112N-1 to 112N-N (collectively, containers 112). A container can refer to a virtual environment in which a program is executable. If the compute cluster 102 is a Kubernetes cluster, then the containers 112 are included in pods, where a pod can include one container or multiple containers. In other examples, a container can also refer to a VM or any other type of virtual computing environment.

The compute cluster 102 further includes a storage provisioner 116 and a storage provider 118, according to some examples. Storage provisioner 116 is the component that faces hosts 126 and interacts with the containers 112 of the compute nodes 110, while storage provider 118 is the component that faces storage arrays 104A to 104N (collectively, 104). Although FIG. 1 shows storage provisioner 116 and storage provider 118 as being separate components, in other examples, storage provisioner 116 and storage provider 118 can be part of the same component. In examples where storage provisioner 116 and storage provider 118 are separate components, storage provisioner 116 can launch fleet storage provider 118 for use in performing storage management operations with respect to storage arrays 104. In some examples, storage provisioner 116 and/or storage provider 118 can be executed on one or more compute nodes 110.

Storage provisioner 116 provides an interface in compute cluster 102 to receive requests pertaining to storage volumes from clients, such as hosts 126 and/or control plane 108. The hosts 126 and/or control plane 108 are able to issue, to storage provisioner 116, requests for performing storage management operations with respect to the fleet of storage arrays 104. A “host” can refer to a user, a program, or a machine that is able to issue requests to compute cluster 102. The hosts 126 are able to communicate with compute cluster 102 over a network 128, such as a local area network (LAN), a wide area network (WAN), a public network, and so forth.

Further still, compute cluster 102 may comprise a storage log analyzer 130 that, in accordance with examples of the disclosed technology, analyze log data regarding the operational behavior(s) of one or more of storage arrays 104. Events regarding the operating behavior(s) of storage arrays 104 can include, but are not limited to device discovery, e.g., pursuant to mounting or onboarding a new or restarted storage array, transmitting and receiving requests and acknowledgements, respectively, regarding the provisioning of a storage array, and so on. As noted above, compute cluster 102 may be a Kubernetes cluster, and as is understood by those of ordinary skill in the art, Kubernetes (through the use of APIs, Kubernetes-specific functions) allows for events to be logged and monitored. Accordingly, storage log analyzer 130 may receive event logs or data associated with storage arrays 104. In accordance with some examples of the disclosed technology, log data or information, such as log entries regarding operational behaviors of storage arrays 104 may be captured by processors of storage arrays 104 (not shown) and forwarded to data services management engine 106 (or obtained by data services management engine 106 from storage arrays 104). Log events can be tracked, monitored, and obtained or transmitted for analysis in non-Kubernetes environments as well. For example, log event data may be obtained by storage array service 120 (described in greater detail below) as part of its functionality and stored in memory 134 to be analyzed, or forwarded by storage array service 120 to compute cluster 102 and stored in memory 124.

As will also be described in greater detail below, storage log analyzer 130 may then select or sample logs or log files of interest, e.g., during busy periods, on a per-day basis, etc., to be analyzed. These log files can comprise a series of log lines or entries representative of the operating behaviors of one or more of storage arrays 104.

Upon selecting a set of log files or entries/lines to analyze, storage log analyzer 130 may convert individual log entries/lines into vector embeddings to facilitate determining similar ones of such log entries/lines. In some examples, clustering techniques can be used to group similar log entries/lines, and optimize the number of resulting clusters (e.g., determine the strictness of similarity), such as assigning silhouette scores to log entries/lines to determine similarity via K-means clustering. Once clusters are defined or determined, i.e., once similar log entries/lines are determined, representative regexes can be derived for an operational behavior pattern that is reflected in (and thereby shared between) the log entries/lines comprising a cluster. These representative regexes can be mapped to some indices, creating a sequence of indices, such as a set of numeric values. In this way, detecting repeating patterns of operational behaviors is simplified into detecting numeric patterns, e.g., repeating patterns of “(1, 0, 1, 1)” or “(0, 1, 15).” Upon determining, such repeating patterns, the log entries/lines corresponding to these repeating patterns can be ignored for purposes of anomalous log entry/line detection.

The analysis of such sequences of indices can be facilitated by scanning for the longest non-overlapping repeating subsequences, replacing such repeating subsequences with (tree) node identifiers. This process can repeat until no more repeating subsequences are found, and a resulting hierarchical tree structure can be generated that includes root, intermediate, and leaf nodes. By virtue of the manner in which nodes are identified/labeled, intermediate nodes will refer to or represent repeating subsequences (recurring, happy path log events), and leaf nodes will refer to or represent unique, anomalous, or otherwise non-standard log entries/lines (or aspects thereof). Root nodes are used to generate the hierarchical tree structure, and do not represent repeating subsequences. In this way, data such as log data can be simplified, and more particularly, de-noised. That is, the data that is not of interest, i.e., the repeating happy path log entries/lines, can be ignored. Any sort of further analysis or application of steps or operations to fix, address, or otherwise remediate any problems associated with the anomalous operational behaviors can be focused on just these behaviors. Therefore, determining what operational behaviors are of important, and further analyzing or addressing such operational behaviors can be accomplished much faster than was possible using conventional technologies. Moreover, such analyses and addressing tends to be more accurate or applicable because non-important or non-relevant data need not be considered. As would be well-understood by those skilled in the art, considering information can result in skewing the analysis or determining an appropriate response when that information is not actually relevant to the data of interest.

In some examples, hosts 126 and/or control plane 108 can issue requests to create, update, and/or delete storage volumes 114 for use by programs running in the containers 112. As noted above, a storage volume is a logical unit of data storage. In examples where compute cluster 102 is a Kubernetes cluster, storage volumes 114A-1 to 114A-N/114N-1 to 114N-N (collectively, 114) are referred to as persistent volumes (PVs). An entity (e.g., a host 126 or control plane 108) can submit a request for creating a storage volume or performing other storage management operations.

In response a request for a storage management operation, storage provisioner 116 can interact with storage provider 118 to perform the requested storage management operation. To perform a storage management operation, storage provider 118 may interact with service 120 that is part of data services management engine 106. Service 120 abstracts component details of storage arrays 104 from the compute cluster 102, so that storage provider 118 would not have to be provided with individual connection information relating to the storage arrays. Storage provider 118 is also provided with connection information 122 that allows Storage provider 118 to communicate with storage array service 120.

In some examples, storage array connection information 122 can be stored in a memory 124, which includes a collection of memory devices (a single memory device or multiple memory devices), or in the memory of a respective compute node 110 when storage provider 118 is executed in a compute node. Storage array connection information 122 can include location information to allow storage provider 118 to access storage array service 120, e.g., location information such as a uniform resource locator (URL) that relates to a location on a network at which storage array service 120 is accessible, IP address, or a Medium Access Control (MAC) address. Connection information 122 can also include credentials to authorize clients (e.g., hosts 126 and/or control plane 108) that request storage management operations with respect to storage arrays 104 through storage provider 118. The credentials can include a username and password, for example, which may be set up when a user registers with compute cluster 102. In other examples, the credentials can include a certificate, a key, or any other secret information that is used by storage provider 118 to verify that a client is authorized to access storage array service 120. Although FIG. 1 shows storage provider 118 as being present in compute cluster 102, in other examples, storage provider 118 can be executed on a computer (or multiple computers) outside compute cluster 102.

It should be noted that while examples of the disclosed technology are described in the context of analyzing system log data, examples of the disclosed technology can be applied to analyzing other types of data or used in other data-generating systems, where the avoidance of analyzing standard or normally recurring operating behaviors can increase anomaly detection and remediation. That is, examples of the disclosed technology can be used and applied to de-noising and compressing data from other data sources.

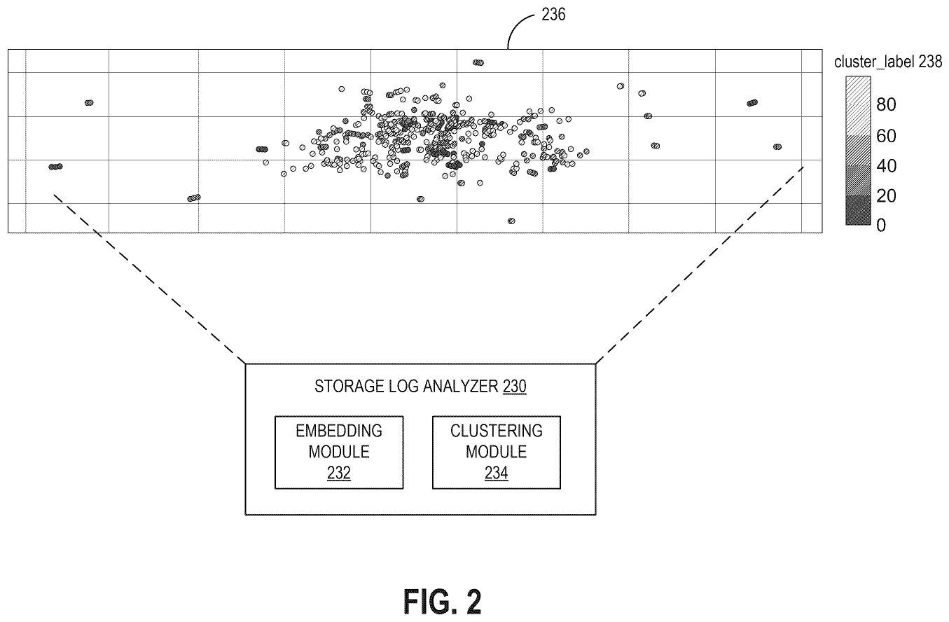

FIG. 2 illustrates a storage log analyzer 230 (which may be the same as or an embodiment of storage log analyzer 130 of FIG. 1). Storage log analyzer 230 may comprise an embedding module 232 and a clustering module 234. As discussed above, storage log analyzer 230 may operate in/as part of compute cluster 102, and may receive or obtain data, such as log data, in the form of log files. Log entries or events that occur at or involve storage arrays 140 can make up such log files that are received or obtained by storage log analyzer 230. Again, such log files can comprise log records reflecting events, such as I/O processing, request/response messages, operational states, errors or failures (such as operating or component errors/failures), periodic or aperiodic messaging or reporting notifications regarding such events, and so on.

Embedding module 232 may use a variety of techniques to convert log entries into embeddings, e.g., vector embeddings. For example, embedding module 232 may employ statistical techniques such as “bag-of-words” or Term Frequency-Inverse Document Frequency (TF-IDF). In some examples, embedding module 232 may employ machine learning-based techniques such as neural networks (e.g., word2vec), encoder-decoder networks (particularly the encoder portions), etc. Graph 236 illustrates a plurality of points representative of example embeddings that may correspond to log entries. In this example, graph 236 represents similarity of embeddings via colors or other identifying mechanisms for ease of illustration, where points (embeddings) that are of the same or similar color are contextually the same/similar.

In some examples, clustering module 234 may group the embeddings in into clusters. As discussed above, embeddings that are the same or similar (in this example, embeddings represented with the same color) can be the basis for grouping the embeddings into clusters. It should be understood that any number of clusters are possible, depending on, e.g., the various types of log entries, the number(s) or type(s) of storage arrays, and so on. Various clustering techniques, such as K-means clustering, may be employed. K may be a positive integer that dictates how many clusters are formed. In some examples, if there are n possible log entry types, then K may be set to n. In other example implementations, new clusters may emerge over time, or preexisting clusters may grow, in response to new issues or log entries emerging. Thus, K (or parameters used to determine cluster counts for other clustering techniques) can be dynamic in many examples. Such clusters may be labeled as desired, in this example, with colors.

In some examples, an optimal number of clusters can be determined using metrics, such as silhouette score, where a silhouette score can be calculated for different numbers of clusters. A value of K (number of clusters) can be selected that yields the highest average silhouette score, which indicates the best clustering solution where data points are well-separated within their clusters. In some examples, data pre-processing such as scaling and feature selection, can be performed to select the value of K. In some examples, clustering can be further enhanced by using techniques like dimensionality reduction (e.g., principal component analysis (PCA)) to visualize and interpret the clusters better.

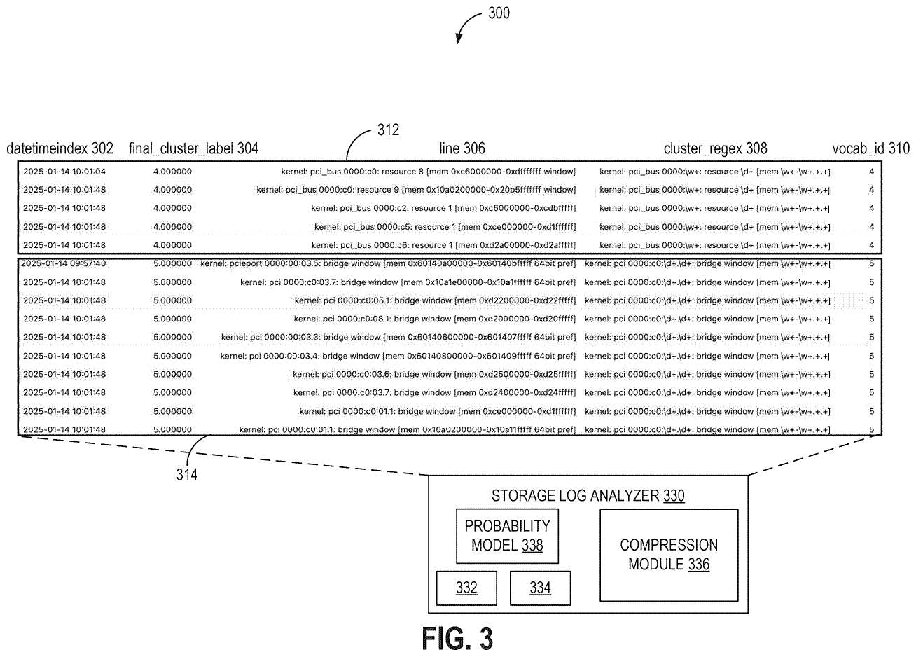

Once clusters that represent the same/similar log entries are determined, clusters can be labeled (cluster_label 238) a regex can be derived that represents the pattern of operational behavior(s) which is shared amongst the log entries that belong to the same cluster. FIG. 3 illustrates an example set of log lines/entries whose corresponding data can be reduced to a sequence of indices to make the detection of anomalous operational behaviors faster, more efficient, or more accurate. As noted above, a set of log lines/entries can be selected to be analyzed, where the set of log lines/entries belong to a desired sample of log data reflecting a busy time, where storage arrays are undergoing many changes, are communicating frequently, etc. In some scenarios, the desired sample of log data may equate to an operational period for storage arrays, such as a day, two days, a week, etc. In some examples, the set of log lines/entries may correspond to a log file. Compression module 336 may operate to analyze sequences of indices to identify repeating and non-repeating patterns (as described in greater detail below). Compression module 336 may be implemented as part of storage log analyzer 330, which may be an embodiment of storage log analyzer 130/230 (of FIGS. 1 and 2), along with embedding module 332 and clustering module 334 (which may be embodiments of embedding module 232 and clustering module 232, respectively, of FIG. 2). In some examples, storage log analyzer 330 may also comprise a probability model 338 that can be used for comparison purposes, where any non-repeating patterns can be compared to probability model 338 which can be derived from an install base representative of storage arrays 104. As will described in greater detail below, this comparison can facilitate analysis of such no-repeating patterns, by helping isolate uncommon patterns to certain storage arrays or processing units, or by helping verify whether purported anomalous operational behaviors are actually anomalous, and so on.

As shown in FIG. 3, log lines/entries 306 can be stored or cached along with information, such as day/time information, or other time-based/chronological identifiers, e.g., date_time indices 302. Such time-based/chronological identifiers can be used as a basis for selecting log data of interest, e.g., log lines/entries that correspond to a busy period, a day's worth of log lines/entries, or other period(s) of interest.

As discussed above, examples of the disclosed technology reduce the dimensionality of log data, and facilitate anomaly detection in the operational behaviors of a subject of interest, here, storage arrays. In an initial phase or step of reducing the dimensionality of data, such as log data, the log data can be converted to embeddings. The similarity of the embeddings can be determined, and similar embeddings (which can be numerical representations of storage array operational behaviors) can be clustered together. The one or more clusters can be labeled, in this example, with “final_cluster_labels” 304.

As can be appreciated from FIG. 3, the subset of log lines 312 represents a first cluster of log lines, meaning the log lines/entries 306 falling in subset 312 are the same/similar, while the subset of log lines 314 represents a second cluster of log lines that are the same/similar. For example, each of the log lines that belong to cluster “4.000000” is a kernel log corresponding to a particular PCI bus, i.e., “pci_bus 0000.” In this example, the remaining data corresponds to volumes, identifiers, e.g., resource identifiers. In operation, storage log analyzer, e.g., storage log analyzer 103 of FIG. 1, can analyze some subset of log lines/entries belonging to a particular cluster.

Here, in the case of cluster 4.000000, storage log analyzer 103 will detect the existence of the term “kernel” in each of the log lines of cluster 4.000000, where “kernel” may be a word. The same analysis is performed to determine the existence of another word, “pci_bus.” The pci_bus identifier in this example is “0000” for all log lines. Given the repetitive existence of the terms “kernel,” “pci_bus,” and the repetitive existence of pci_bus identifier “0000,” a generated or derived regex that represents this subset of line entries/logs maintains these terms in the regex representation. The “pci_bus” identifiers follow the format “0000:cN”, where N is a number or integer, e.g., “0000:c0,” “0000:c2,” “0000:c6,” etc. These identifiers are not necessarily consistent across all the log lines of cluster 4.000000, and thus can be replaced in the resulting regex with, in this example, a “\w+.” Continued regex derivation will identify the existence of the term “resource” across all log lines f cluster 4.000000, and the resulting regex will retain the term. Regex derivation will identify the existence of resource identifiers, e.g., “8,” “9,”, and “1,” along with the repeated existence of the term “mem,” and remaining identifiers, such as “0xc6000000,” and “0xdfffffff window,” “0x10a02000000,” and “0x20b5fffffff window,” “0xc6000000, and “0xcdbfffff.” The term mem can be retained in the regex, while the identifying information can be replaced, in this example, with “\d+,” “\w+” and “\w+.+.+.” Thus, the first log line, which originally reads “kernel: pci_bus 0000:c0: resource 8 [mem 0xc6000000-0xdfffffff window]” can be represented by regex “kernel: pci_bus 0000:\w+: resource \d+ [mem \w+−\w+.+.+].” As a result of this regex generation, the log lines belonging to cluster 4.000000 can be represented with a single, common cluster regex 308. It should be noted that various regex generator tools or applications can be used to convert or transform plain-language context into regex representations. As used herein, a regex or regex representation can refer to some sequence of characters, e.g., a string, that specifies some pattern in text. Other transformations can be used/implemented, but regex allows for a language model to look at constructs while ignoring variables to achieve the above-described representations.

Now that regexes are generated for the one or more determined clusters, the regex representations can be assigned a unique index, thereby forming a vocabulary of indices 310. In the example of FIG. 3, the regexes representing the log lines/entries that belong to cluster 4.000000 are assigned an index of 4, while the regexes representing the log lines/entries that belong to cluster 5.000000 are assigned an index of 5. The log lines/entries can be replaced with these unique indices as appropriate, and the resulting set of log lines/entries can now comprise a sequence of indices. In the example of FIG. 3, that sequence of indices is “[4, 4, 4, 4, 4, 5, 5, 5, 5, 5, 5, 5, 5, 5].” As can be appreciated, the log data is now even further reduced in dimensionality, and patterns regarding the operational behaviors of the storage arrays associated with this data (now reduced in dimensionality to single unique indices).

The analysis of the resulting sequence of indices can comprise detecting repeating patterns in the sequence of indices. Patterns such as “[1, 15],” or “[0,1],” or “[0, 1, 15],” may be identified and can be mapped back to their original log contexts. That is, and recalling that log lines/entries may be first clustered according to similarity, resulting clusters can be labeled. Regex representations can be generated or derived for contextual patterns that exist in the log lines/entries on a per-cluster basis. Because the log lines/entries that belong to a cluster are the same/similar, the regex representation reflects a common contextual pattern amongst the log lines/entries of that cluster, which can then be represented as indices. Accordingly, such repeating patterns, once identified, can be reverted back to their respective original log data context by mapping a node identifier (discussed in greater detail below) back to it corresponding index, mapping the index back to its corresponding regex, and mapping the regex back to the log entry text. Following the above example, this reverting back results in an index 4, which represents regex “kernel: pci_bus 0000:\w+: resource \d+ [mem \w+−\w+.+.+],” can be converted or mapped back to “kernel: pci_bus 0000:c0: resource 8 [mem 0xc6000000-0xdfffffff window].”

Any patterns that do not repeat can be compared to a probability model derived from an install base. Such a probability model can be any appropriate representation of the prevalence of log entries across similar systems, in this case, similar storage arrays. For example, a database with the longest non-repeating sequences representative of log events found across the storage arrays can be built, and a probability for the log event sequences can be calculated by dividing the number of storage arrays in which a log event sequence is detected by the total number of storage arrays.

That is, the probability model can provide a check or reference against which any non-repeating patterns of storage array operational behaviors can be compared. For example, if a particular non-repeating pattern associated with a particular storage array processor has been identified, that non-repeating pattern can be checked against a probability model that represents, e.g., other storage array processors in a deployment.

Because the probability model can estimate the prevalence of log entries across other storage array processors, in this example, the probability mode can help isolate uncommon or anomalous (non-repeating) patterns. That is, if the same non-repeating pattern detected for one storage array processor has been detected as occurring in other storage array processors, that non-repeating pattern may not necessarily be anomalous, or while anomalous, it may be specific only to certain storage array processors. In other words, use of a probability model can provide further insight into operational behaviors, and what may need to be addressed, remediated, etc., or how such operational behaviors should be addressed, remediated, etc. In other words, how often that same non-repeating pattern was found to exist with respect to other storage array processors can help determine how unique or anomalous the operational behavior associated with/represented by the non-repeating pattern may be from a desired perspective, such as a system-wide perspective.

It should be noted that the install base need not necessarily be all storage arrays in a system or deployment. Rather, the install base or baseline can be some subset of the storage arrays of interest in the system or deployment. In other examples, the probability model can be used to define thresholds against which the occurrence of the non-repeating patterns may be compared. For example, the probability model may suggest that the occurrence of the non-repeating pattern 1× per day of operation is not problematic, but the occurrence of the non-repeating pattern more than 1× per day is an anomalous occurrence that could be indicative of some operational problem or issue.

Regarding the repeating pattern detection, examples of the disclosed technology more particularly perform a tree-based iterative compression method that transforms the above-described index sequences into hierarchical structures that allow for the extraction of non-repeating/anomalous operational behaviors from data, such as log event data as described herein. Generally, the tree-based iterative compression method recursively identifies and replaces repeating subsequences of indices in order to efficiently compress the log event data (i.e., log entries/lines), while preserving their contextual integrity. Preserving contextual integrity can be useful when assessing how to address or remediate (or simply further evaluate) an operational behavior(s) reflected in a non-repeating pattern/sequence of indices. For example, a repeating pattern(s) that precede a non-repeating pattern can signify some operational behavior(s) that triggers the anomalous operational behavior.

In some examples the TBIC method begins by scanning a sequence of indices representing some subset of log data that is of interest to a user/the system in which storage arrays operate. As discussed above, that subset of log data can be a collection of daily log entries/lines, a collection of log entries/lines that were generated/received during a system's busy time, and so on. This scanning is performed to identify the longest non-overlapping repeating subsequences within the sequence of indices. In some examples, this can be accomplished with run-length encoding (RLE), which is well-suited to compressing data with many repeated values, in this case, repeated integers (indices). Such non-overlapping repeating subsequences represent recurring patterns of operational behavior(s) that exist or appear in log data.

Subsequences of indices that are identified as being non-overlapping and repeating, such as, e.g., “[1, 15],” or “[0,1],” or “[0, 1, 15],” can be replaced with a unique node identifier. That is, the actual sequence of indices can be further reduced in dimensionality, as they are now represented with a single node identifier instead of a sequence (plurality) of indices/integers.

The above process of identifying the longest repeating subsequences and replacing such subsequences with node identifiers can be repeated to find additional repeating subsequences. It should be understood that after the initial identification of the longest non-overlapping and repeating subsequences, and after the replacement of those subsequences with node identifiers, subsequent identification and replacement operations can be performed on subsequences that can include both integers and node identifiers. For example, a subsequence may now equate to, “[node x, 1, 1]” or “[0, node x].” These recursive compression operations can be repeated until no more repeating subsequences are identified or detected.

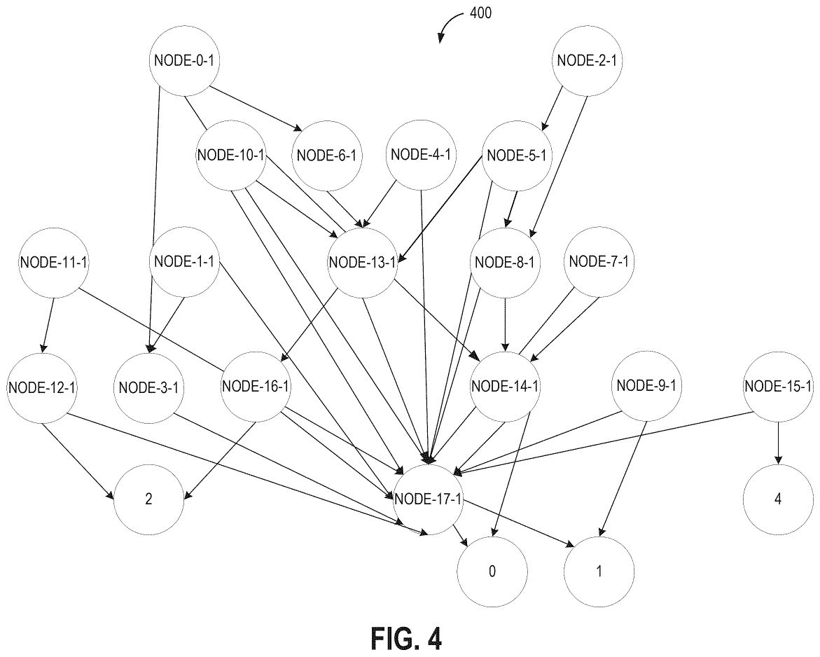

FIG. 4 illustrates an example of a hierarchical tree structure 400 that can be generated based on the above-described compression process. As illustrated in FIG. 4, there are two root nodes (“node-0-1” and “node-2-1”), sixteen intermediate nodes (“node-3-1” through “node-17-1”), and four leaf nodes (“node 0,” “node 1,” “node 2,” and “node 4”) making up hierarchical tree structure 400. Being replacements for identified subsequences of indices, hierarchical tree structure 400 is a compressed, graphical representation of, e.g., thousands of log lines/entries. The arrows in FIG. 4 represent the “flow” of a log data, i.e., hierarchical tree structure 400 can be a directed graph. That is, a particular non-overlapping, repeating pattern representative of a repeating log entry/line may lead to or arise from some other index or subsequence of indices, and the arrows reflect these relationships. Thus, the contextual information/relationships between operational behaviors can be preserved, and as noted above, can help define or characterize issues or problems associated with certain operational behaviors, e.g., a particular subsequence of indices always precedes a non-repeating subsequence of indices. In log data terms, it can be determined, for example, that the performance of some operational behavior or set of operational behaviors leads to the anomalous operational behavior.

Thus a hierarchical tree structure, such as hierarchical tree structure 400, can be a visual or graphical representation of a set log lines/entries in a compressed form that can be used to efficiently and easily identify unique or possibly anomalous operational behaviors in that set of log lines/entries. In this example, “node-17-1,” an intermediate node, can represent some commonly-detected operational behavior, such as an acknowledgement in response to a typical status request (hence the relationship (evidenced by the arrows directed to “node-17-1”) to many other nodes. In contrast, node 4, for example, can represent a non-repeating operational behavior, i.e., some unique operation(s) or action(s). It should be noted that multiple iterations of the hierarchical tree structure 400 may be generated if the TBIC method iterates through a sequence of indices multiple times, the multiple iterations resulting in more and more compressed graphical representations of the sequence of indices.

As an example, an input sequence of indices (e.g., input to compression module 336) may be “[1, 0, 1, 0, 3, 4, 4, 5, 1, 0, 3, 4, 4, 5, 1, 0, 0, 1, 1, 4, 4].” As described above, such a sequence of indices may be scanned/analyzed to determine the longest, non-overlapping repeating subsequence(s). After a first iteration, a longest, non-overlapping repeating subsequence is “[1, 0, 3, 4, 4, 5].” As also described above, and as part of the compression aspect of TBIC, the numbers/integers that make up this repeating subsequence are replaced with node identifiers. As an example, the subsequence “[1, 0, 3, 4, 4, 5]” is replaced with the node identifier “node-1-0.” Accordingly, the original input sequence of indices after the first compression iteration becomes “[1, 0, node-1-0, node-1-0, 1, 0, 0, 1, 1, 4, 4].”

In a second iteration, the sequence of indices “[1, 0, node-1-0, node-1-0, 1, 0, 0, 1, 1, 4, 4]” can be scanned/analyzed again to determine longest, non-overlapping repeating subsequences that remain/still exist after the first compression iteration. In this next sequence of indices, the longest, non-overlapping repeating subsequence is the subsequence “[1, 0].” The numbers/integers that make up this particular repeating subsequence are again replaced with node identifiers, this time, with the node identifier, “node-2-0.” Accordingly, the sequence of indices “[1, 0, node-1-0, node-1-0, 1, 0, 0, 1, 1, 4, 4]” becomes “[node-2-0, node-1-0, node-1-0, node-2-0, 0, 0, 1, 1, 4, 4].” As noted above, subsequent compression iterations can be performed until no more repeating subsequences remain. For example, in the above, example, additional subsequences exist, i.e., “[0, 0],” “[1, 1],” and “[4, 4].”

After naming the repeating subsequences with node identifiers, and determining the existence of non-repeating subsequences (if they in fact, exist), the hierarchical tree structure, such as that illustrated in FIG. 4 can be generated. Generating the hierarchical tree structure can be an iterative process whereby in a first iteration, an attempt can be made to try to find subsequences that are some fraction or portion of the length of an original sequence. For example, an attempt can be made to try to find subsequences that are ⅓ the length of the original sequence, and then those subsequences may be scanned/analyzed to identify repetitive subsequences. In a next iteration, the size of the subsequence being searched for can be reduced in size, until subsequences reach a length of 2 indices. For each iteration, the repeating subsequence is replaced with a representation of a node. In a subsequent iteration, the sequence that now includes replaced subsequences (replaced with their node representations) is the “new” sequence, and scanning/analysis of this new sequence is performed, repeating the process. Because this is an iterative process, going from bottom to top, a tree structure is generated.

In some examples, optimization steps can be taken to further compress index subsequences that represent operational behaviors. Such optimization steps can be performed on their own, as desired, or in combination with one another to achieve desired insight. In some scenarios, redundant nodes of a hierarchical tree, such as hierarchical tree 400, can be identified, and ignored. That is, nodes with a single child, where that child is another node (versus a non-repeating subsequence of indices) without any leaves, can be ignored and left off/removed. These parent nodes of single child nodes do not add meaningful information because they are redundant, and by virtue of them only have a single child node without any leaves, they do not contribute contextually, to the understanding of the hierarchical tree. It should be noted that child nodes may keep getting consolidated with each scanning/analysis iteration. As discussed above, after an iteration over a sequence, a new sequence results, where some of the indices have been converted into nodes that combine a subsequence. For a subsequent iteration, the new nodes become the new indices. At the end of the iterative process (again, when no more repeating subsequences exist), there is traceability from the nodes in the final sequence all the way back to the individual elements/indices from the child nodes.

Another optimization step that can be taken is the replacing of node identifiers based on matching content. As discussed herein, de-noising and compression is an iterative/recursive process. Accordingly, deeper structures may emerge when recursively applying compression by replacing patterns with node identifiers and running the process again. Moreover, patterns can be embedded in other patterns—hence the iterative/recursive process. Single-pass replacement of repeating patterns with node identifiers could result in missing higher-order structures in the log data. For example, consider a scenario, where a first iteration finds the pattern “[A, B, C, A, B, C],” which is then replaced with identifier “Node-X.” A next iteration may identify that “Node-X” itself appears frequently with “[D, E],” leading to another compressed pattern. Without multiple passes, the repeating subsequence, “[Node-X, D, E]” may not be identified.

In accordance with some examples, after a hierarchical tree is generated, a map can be created from the hierarchical tree by counting the number of items (e.g., leaf nodes or child nodes) associated with a particular node. In this way, nodes can be ranked by significance based on their leaf/child node associations. For example, anomalous patterns may become evident due to low frequency. That is, “rare” sequences (those that do not appear frequently across different logs or in multiple places within that log) will be assigned unique node identifiers, but will have fee occurrences in the hierarchy. If a pattern appears infrequently, e.g., just once, the pattern may reflect some anomalous operational behavior. Additionally, sequences can potentially break expected patterns. That is, if a particular pattern always follows a specific sequence in normal operation (e.g., A→B→C), and it is observed that now, the sequence is A→X→C, this deviation from the norm can indicate some system issue, or failure condition. Such patterns can be flagged for deeper analysis. Further still, if a new sequence representative of the log data does not match any other previously-observed pattern(s), or only loosely resembles the previously-observed patterns, an issue/problem might be present. Conversely, if a sequence partially matches a prior sequence that was known to be associated with a failure condition, recognition of the partial match can be leveraged to help characterize or categorize the new issue faster.

In still other examples, nodes of a hierarchical tree can be sorted in descending order of frequency, as determined by the above-described count map. Again, this can help provide insights into operational behaviors, such as detecting performance bottlenecks in I/O processing, identifying normal and expected operational patterns, analyzing anomalous device failures, understanding uncommon, but critical failure conditions, and detecting inefficient storage workflows.

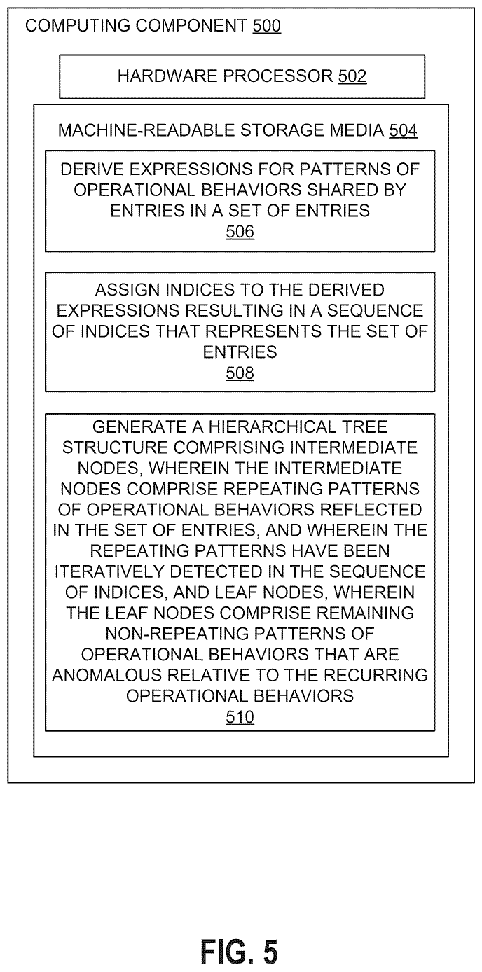

FIG. 5 illustrates a computing component that may be used to implement data compression and de-noising in accordance with various examples of the disclosed technology. Referring now to FIG. 5, computing component 500 may be, for example, a server computer, a controller, or any other similar computing component capable of processing data. In the example implementation of FIG. 5, computing component 500 includes a hardware processor 502, and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-510, to control processes or operations for burst preloading for available bandwidth estimation. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-510.

Hardware processor 502 may execute instruction 506 to derive expressions for patterns of operational behaviors shared by entries in a set of entries, e.g., some character-based, numerical, textual, or other representation of a series of operational behaviors that repeat in some regular/recurring fashion. As described above, systems such as storage array systems may track and log events. Accordingly, a storage array system can produce log files that comprise log entries/lines indicating operations performed by or engaged in by the storage array system. The volume of log events can be enormous, and examples of the disclosed technology can de-noise and compress log event data, and ultimately create a hierarchical tree structure to represent the log events. The hierarchical tree structure can be useful for identifying unique or anomalous events, as opposed to repeating patterns of operational behaviors that do not need to be analyzed, as they can be considered to be “standard” events. Thus, the universe of data that is to be analyzed can be reduced by orders of complexity.

Such log events can be vectorized to generate embeddings upon which the similarity of log events can be determined. Similar log events (based on their corresponding vector embeddings) can be clustered together. A pattern of operational behavior(s) shared by the log events that are clustered together can be identified, and an expression, such as a regex expression can be derived for this pattern.

The log event data undergoes one phase of compression by the derivation of a regex expression that can be used to represent the log event data instead of the actual log event data/contents itself being used for analysis. As described above, commonly-shared words or portions between log entries of a set of log entries being analyzed, can be retained, while non-common portions, such as resource identifiers, can be replaced with simpler identifiers or representations in the regex expression.

Hardware processor 502 may execute instruction 508 to assign indices to the derived expressions resulting in a sequence of indices that represents the set of entries. Because the clusters group together similar log events, the use of an index, such as an integer, to represent the derived expression, can further reduce the complexity of the log event data. For example, as discussed above, an entire regex representation can be reduced to a single integer without losing contextual or relationship information of the log event data.

Hardware processor 502 may execute instruction 510 to generate a hierarchical tree structure comprising intermediate nodes, wherein the intermediate nodes comprise repeating patterns of operational behaviors reflected in the set of entries, and wherein the repeating patterns have been iteratively detected in the sequence of indices. The hierarchical tree structure further comprises leaf nodes, wherein the leaf nodes comprise remaining non-repeating patterns of operational behaviors that are anomalous relative to the recurring operational behaviors. As described above, the sequence of indices which represents operational behaviors captured as log events can be iteratively processed or analyzed to further compress/de-noise the log event data. For example, once a sequence of indices is derived, that sequence of indices comprises integers representative of the log event patterns. Examples of the disclosed technology, using, e.g., RLE (or other pattern detecting mechanism(s)) can identify patterns within the sequence of indices. Such patterns are the longest non-overlapping repeating patterns identified in the sequence of indices. Any such patterns can then be labeled or replaced with node identifiers. This phase of compression can be repeated to further compress/de-noise the log event data until no more repeating patterns can be identified. A hierarchical tree structure can then be created based on the node identifiers, and any remaining indices. The node identifiers representative of repeating patterns can be characterized or represented in the hierarchical tree structure as intermediate nodes, while the remaining indices may be characterized or represented as leaf nodes. The hierarchical tree structure allows for easy, efficient, and non-data intensive identification of unique or anomalous indices, which can be mapped back to their corresponding log event data content. At this point, a user or system can made aware of potentially problematic operating behaviors occurring within the storage array system. In some examples, as also described above, various optimization steps to further facilitate operational behavior analysis or remediation can be performed after a hierarchical tree structure has been developed, such as ranking nodes (which ultimately represent operational behaviors) to determine their significance.

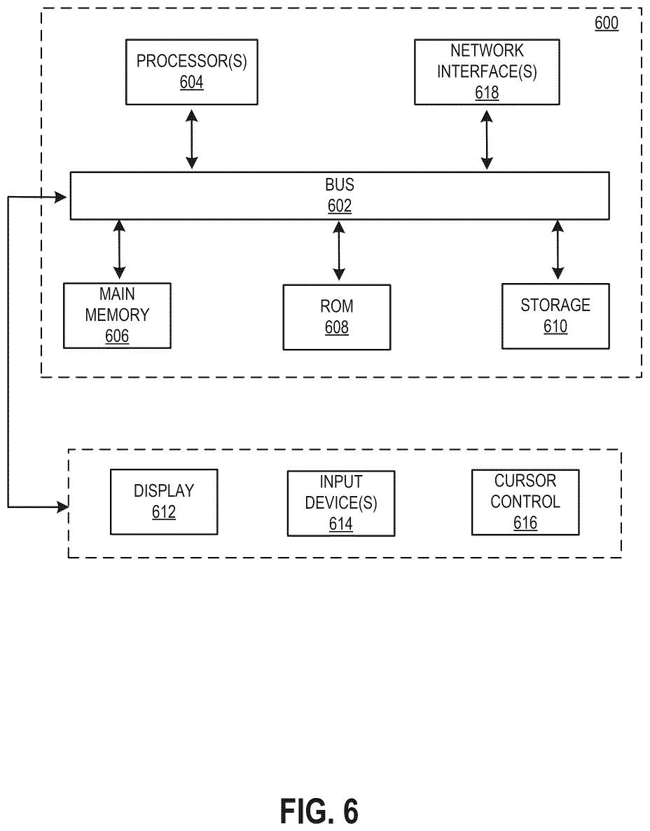

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. It will be appreciated that software components may be callable from other components or from themselves, and/or may be invoked in response to detected events or interrupts.

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Non-transitory media is distinct from but may be used in conjunction with transmission media.

The computer system 600 also includes a communication interface 618 coupled to bus 602. Network interface 618 provides a two-way data communication coupling to one or more network links that are connected to one or more local networks. A network link typically provides data communication through one or more networks to other data devices.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

What is claimed is:

1. A method comprising:
deriving expressions for patterns of operational behaviors shared by entries in a set of entries;
assigning indices to the derived expressions resulting in a sequence of indices that represents the set of entries; and
generating a hierarchical tree structure comprising:
intermediate nodes, wherein the intermediate nodes comprise repeating patterns of operational behaviors reflected in the set of entries, and wherein the repeating patterns have been iteratively detected in the sequence of indices; and
leaf nodes, wherein the leaf nodes comprise remaining non-repeating patterns of operational behaviors that are anomalous relative to the recurring operational behaviors.

2. The method of claim 1, further comprising, prior to deriving the expressions for the patterns of operational behaviors, converting the entries into vector embeddings.

3. The method of claim 2, further comprising determining entries that are similar based on the vector embeddings, and grouping the entries that are similar to create one or more clusters of entries, the one or more clusters of entries representing the operational behaviors shared by the entries.

4. The method of claim 3, wherein the derived expression comprises a regular expression (regex).

5. The method of claim 1, wherein the repeating patterns of operational behaviors reflected in the set of entries comprise longest non-overlapping repeating subsequences of the sequence of indices.

6. The method of claim 5, further comprising replacing the subsequences in the sequence of indices with unique node identifiers, the unique node identifiers identifying the intermediate nodes and the leaf nodes.

7. The method of claim 6, further comprising mapping the unique node identifiers identifying the intermediate nodes and the leaf nodes back to their respective indices.

8. The method of claim 7, further comprising mapping the respective indices of the intermediate nodes and the leaf nodes back to their respective derived expressions.

9. The method of claim 8, further comprising mapping the respective derived expressions of the intermediate nodes and the leaf nodes back to textual representations of their respective entries.

10. The method of claim 1, further comprising performing one or more operations intended to remediate one or more issues causing the anomalous operational behaviors based on analysis of the anomalous operational behaviors identified by the leaf nodes of the hierarchical tree structure.

11. The method of claim 1, wherein the entries comprise log entries representative of log events occurring in a storage array system.

12. The method of claim 11, further comprising comparing the log events to a probability model representative of the storage array system to facilitate analysis of the anomalous operational behaviors.

13. A system, comprising:
a data source generating log entries representative of operational behaviors occurring at or related to operation of the data source;
a clustering module adapted to determine log entries that are similar, and represent the log entries that are similar with a common expression; and
a compression module adapted to compress the expressions representative of the log entries into node identifier representations that identify nodes of a hierarchical tree structure representative of the log entries, wherein intermediate nodes represent repeating patterns of operational behaviors, and wherein leaf nodes comprise non-repeating patterns of operational behaviors that are anomalous relative to the repeating patterns operational behaviors.

14. The system of claim 13, further comprising an embedding module adapted to convert the log entries into vector embeddings that allow the clustering module to determine the log entries that are similar.

15. The method of claim 13, wherein the expression comprises a regular expression (regex).

16. The method of claim 13, wherein the compression module is further adapted to compress the expressions into a sequence of indices prior to compressing the expressions into node identifier representations.

17. The method of claim 16, wherein the repeating patterns of operational behaviors comprise longest non-overlapping repeating subsequences of the sequence of indices.

18. One or more non-transitory computer-readable storage mediums having stored thereon, executable computer program instructions that, when executed by one or more processors, cause the one or more processors to perform operations comprising:
converting textual representations of log entries into vector embeddings;
clustering together vector embeddings that represent log entries that are similar;
representing the log entries that are similar with common expressions;
converting the expressions into a sequence of indices;
determining repeating subsequences and non-repeating subsequences of the sequence of indices; and
generating a hierarchical tree structure representing the repeating subsequences and non-repeating subsequences as nodes of the hierarchical tree structure to facilitate identification of log entries associated with anomalous operational behaviors of a source system that generated the log entries.

19. The one or more non-transitory computer-readable storage mediums of claim 18, wherein the executable computer program instructions further comprise instructions that cause the one or more processors to map node identifiers identifying the nodes of the hierarchical tree structure back to the textual representations of the log entries corresponding to the nodes.

20. The one or more non-transitory computer-readable storage mediums of claim 18, wherein the executable computer program instructions further comprise instructions that cause the one or more processors to compare the log entries to a probability model representative of the source system to facilitate analysis of the anomalous operational behaviors.
